(19) United States
(12) Patent Application Publication
(10) Pub. No.: US 2008/0137231 A1
(43) Pub. Date: Jun. 12, 2008

(54) MAGNETIC RECORDING MEDIUM AND METHOD OF FABRICATING THE SAME

(75) Inventors: Chee-kheng LIM, Suwon-si (KR); Jin-seung SOHN, Seoul (KR); Byun-kyu LEE, Seoul (KR); Eun-hyoung CHO, Seoul (KR); Hae-sung KIM, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/758,795

(22) Filed: Jun. 6, 2007

(30) Foreign Application Priority Data
Dec. 8, 2006 (KR) 10-2006-0125072

(51) Int. Cl. G11B 5/74

(52) U.S. Cl. 360/131

(57) ABSTRACT

Provided are a magnetic recording medium and a method of fabricating the same. The magnetic recording medium includes a substrate; and a recording layer, wherein the recording layer is formed of a plurality of magnetic dots, and a non-magnetic region that is formed on the substrate to isolate each of the magnetic dot.

### CROSS-REFERENCE TO RELATED PATENT APPLICATION

This application claims the benefit of Korean Patent Application No. 10-2006-0125072, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a magnetic recording medium and a method of fabricating the same. In particular, it relates to a magnetic recording medium having nano scale magnetic dots and a method of fabricating the magnetic recording medium.

2. Description of the Related Art

In a perpendicular magnetic recording medium, information is recorded in a magnetic thin film containing magnetically disrupted magnetic grains or crystal structures, by magnetizing crystals in a predetermined direction to record a “0” or “1” bit signal. For performing high-density magnetic recording, it is necessary to reduce the size of magnetic crystals, each of which is a recording unit of information. However, if the size of crystals is reduced below a certain limit, instability of the magnetic recording medium occurs due to a super paramagnetic limit. As a result, it is not possible to maintain the stability of the magnetic recording medium, and a signal to noise ratio is reduced. When a magnetic filed signal is reduced, recorded information cannot be read.

In a patterned magnetic recording media, a recording layer consists of discrete single magnetic domain elements (or dots). This patterned magnetic dot-array is considered as one of the possible candidates for the future ultra-high-density recording media. In these media, a magnetic dot array is micro-fabricated, composed of single domain particles with strong perpendicular magnetic anisotropy, and must show a good thermal stability. In the patterned magnetic recording media, a “0” or “1” bit signal is recorded by magnetizing each of the dots in a predetermined direction. Accordingly, the patterned magnetic recording medium has increased storing capacity and the conventional problems of super paramagnetic limit and low signal to noise ratio can be avoided.

However, a magnetization switching field of each dot is difficult to control and, in fact, a large dispersion of H is reported in the patterned media. The dispersion of in dot-arrays was considered to arise from the spatial dispersion of magnetic easy axis, fluctuation of dot shape and the magnetostatic interaction among the dots.

Meanwhile, as the recording density of the magnetic recording medium increases, a region in which minimum information unit is recorded, that is, a bit size, is reduced. Thus, the dot pattern is formed to have a size of a few tens of nanometers. Theoretically, a switching field for recording a “1” bit signal and a switching field for recording a “0” bit signal are the same, however, in a dot-array in which a plurality of dot patterns are formed, a switching field dispersion is caused due to magneto-static interaction between adjacent dot patterns. The switching field dispersion means that the switching field, that is, a magnetic field required for changing the magnetization direction of the patterned dots, is different from dot to dot.

To obtain reliability and stability of a magnetic recording medium, the switching field dispersion must be as small as possible.

### SUMMARY OF THE INVENTION

The present invention provides a magnetic recording medium having magnetic dots in a recording layer, in which the magnetic dots have a first surface and a second surface and the dimension of the first surface is not equal to the dimension of the second surface, and sidewalls of the magnetic dots each form an angle which is not equal to 90 degrees with respect to the substrate surface. The magnetic recording layer shows a reduced switching field dispersion. The magnetic dots may have perpendicular magnetic anisotropy.

The present invention also provides a method of fabricating the magnetic recording medium.

According to an aspect of the present invention, there is provided a magnetic recording medium comprising a substrate; a recording layer formed on the substrate; wherein the recording layer is formed of a plurality of discrete magnetic dots and a non-magnetic region, the non-magnetic region isolating the magnetic dots from each other; wherein the magnetic dots each have a first surface and a second surface, the second surface being opposite to the first surface, in which the dimension of the first surface is not equal to the dimension of the second surface, and a sidewall of the respective magnetic dots form an angle which is not equal to 90 degrees with respect to the substrate surface,

According to the present invention, the magnetic dot may have a truncated cone shape, a truncated pyramid shape, a cone shape, a reversed truncated cone shape, or a truncated pyramid shape.

According to another aspect, there is provided a method of fabricating a magnetic recording medium, comprising: forming a mold layer on a substrate, the mold layer being non-magnetic; patterning the mold layer to form a pattern providing a plurality of grooves whose top area dimension is not equal to the dimension of a bottom area; and filling a magnetic material in the grooves to form magnetic dots which each have the shape of the grooves.

According to the present invention, the pattern may be a non-magnetic region that isolates the magnetic dots.

The method may further comprise removing the pattern and applying a non-magnetic material to form a non-magnetic region that isolates the magnetic dots form each other.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a magnetic recording medium having magnetic dots according to an embodiment of the present invention;

FIG. 2 is a cross-sectional view illustrating a magnetic recording medium according to another embodiment of the present invention;

FIGS. 3A through 3D are perspective views of magnetic dots formed in a magnetic recording medium according to an embodiment of the present invention;

FIGS. 4A through 4C are cross-sectional views illustrating a method of fabricating a magnetic recording medium according to another embodiment of the present invention; and

FIG. 5 is a graph showing a simulation result of a switching field dispersion characteristic according to a ratio of a top surface area to a bottom surface area of a magnetic dot according to an embodiment of the present invention.

### DETAILED DESCRIPTION OF THE INVENTION

The present invention will now be described more fully with reference to the accompanying drawings in which exemplary embodiments of the invention are shown.

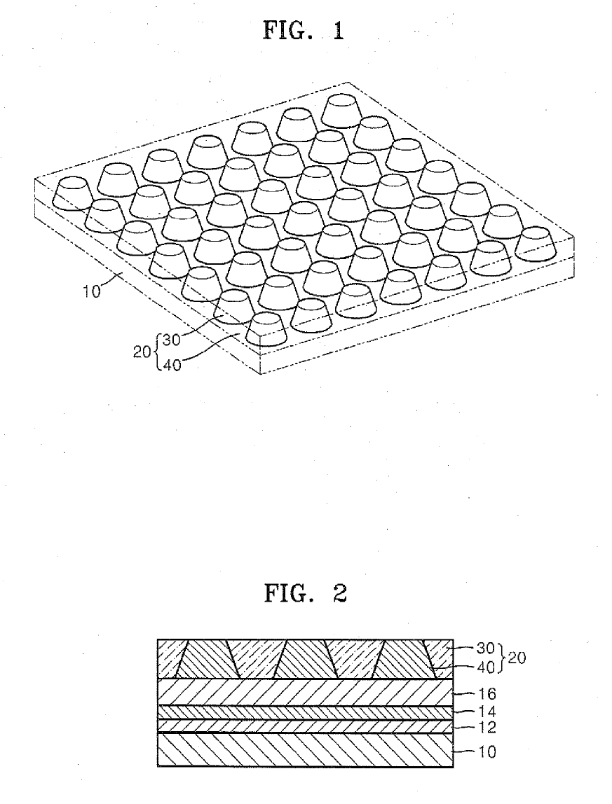

FIG. 1 is a perspective view illustrating a magnetic recording medium having magnetic dots according to an embodiment of the present invention.

Referring to FIG. 1, the magnetic recording medium according to an embodiment of the present invention has a structure that includes a substrate 10 and a recording layer 20 formed on the substrate 10. The recording layer 20 is formed of a plurality of magnetic dots 30 and a non-magnetic region (or non-magnetic peripheral matrix) 40. The magnetic dots 30 may be in a form of an array of regularly arranged dots.

The substrate 10 can be formed of silicon, glass, or an alloy of aluminum. The recording layer 20 has a thickness of a few nanometers to a few tens of nanometers.

The magnetic dots 30 are formed of a material that can store information, for example, a magnetic material whose magnetization may be reversed through a reaction with a magnetic leakage flux of a read/write head or a ferromagnetic material having a dielectric constant different from that of the peripheral matrix 40. The magnetic dots 30 are formed in arrays where the dots 30 are regularly arranged. They may have a size of tens of nanometers. The magnetic dots 30 have a bottom surface that contacts the substrate 10 and a top surface on the opposite side, wherein the dimension of the bottom surface is not equal to the dimension of the top surface. That is, the circumference of the cross-sectional area of the dot 30 is not constant along its height. Therefore, sidewalls of the dots from an angle which is not equal to 90 degrees with respect to the substrate surface. In one embodiment, the dots 30 have continuous slope along their sidewall in a perpendicular direction with respect to the substrate surface.

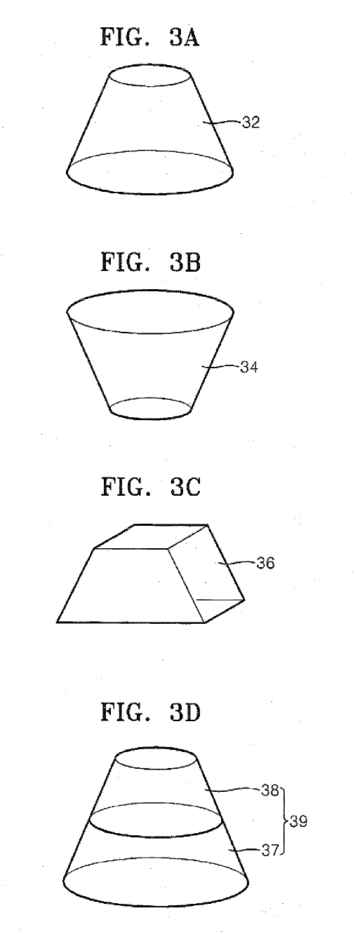

The magnetic dots 30 may be formed to have various shapes as long as the bottom surface dimension is not same to the top surface dimension. Exemplary embodiments of the shapes of the dots 30 are shown in FIGS. 3A-3D, which will be described in more detail hereinafter. The recording layer 20 may have magnetic dots 30 of an identical shape or combinations of different shapes.

A passivation film (not shown) can further be formed on the recording layer 20 to protect the recording layer 20 that consists of the magnetic dots 30 and the non-magnetic regions 40. Also, a lubricant layer (not shown) can further be formed on the passivation film to prevent magnetic heads and the passivation film from wearing due to collision and contact therebetween.

FIG. 2 is a cross-sectional view illustrating a magnetic recording medium according to another embodiment of the present invention. Like reference numerals are used to indicate elements that are substantially identical to the elements of FIG. 1, and thus the detailed description thereof will not be repeated.

Referring to FIG. 2, the magnetic recording medium contains additional layers including a seed layer 12, a soft magnetic under layer 14, and an intermediate layer 16, which are stacked between the substrate 10 and the recording layer 20.

The seed layer 12 is formed of a metal such as Ta, Cr, or Ti. It has high adhesiveness to the substrate 10.

The soft magnetic under layer 14 provides a pathway in a recording operation, to form a closed circuit through which a flux leaked from a main magnetic pole of a recording head can pass the recording layer 20 and the soft magnetic under layer 14 and move to an auxiliary magnetic pole. The soft magnetic under layer 14 also increases the gradient of the recording magnetic field intensity to cause a magnetic transition in a tracking direction of the magnetic recording medium. The soft magnetic under layer 14 can be formed of a soft magnetic material having high magnetic permeability and low coercive force, and can be formed in a multi-layered structure. The soft magnetic under layer 14 can be formed of a soft magnetic alloy selected from the group consisting of CoZrNb, NiFe, NiFeMo, and CoFeNi.

The intermediate layer 16 may be applied to a thickness of a few nanometers to a few tens of nanometers on the soft magnetic under layer 14 to increase the orientation of the magnetic dots 30 in a desired crystal face direction and to control the size of dots 30 of the recording layer 20. The intermediate layer 16 can be formed of a metal selected from the group consisting of Ti, Ru, Pt, Cu, Au, and an alloy of these metals.

FIGS. 3A through 3D are perspective views of magnetic dots formed in a magnetic recording medium according to an embodiment of the present invention.

The magnetic dots according to the present embodiment have a structure in which the dimension of the top surface is different from the dimension of the bottom surface. In conventional magnetic dots, the dimension of the top surface is equal to the dimension of the bottom surface, and a magnetic moment is formed in a direction perpendicular with respect to the substrate surface along vertical sidewalls of the magnetic dots. Thus, a magnetic moment reversal process changes depending on thermal fluctuation. However, in the magnetic dots according to the various embodiments of the present invention, the magnetic moment reversal process occurs due to a magnetic field applied to the magnetic dots, since sidewalls of the magnetic dots according to various embodiments of the invention form an angle which is not equal to 90 degrees with respect to the substrate surface. Accordingly, the switching field is uniform.

The magnetic dots in the magnetic recording medium according to the present invention may have various shapes as long as the dimension of one surface is not equal to the dimension of the opposite surface so that sidewalls of the dots form an angle which is not equal to 90 degrees with respect to the substrate surface. For example, referring to FIGS. 3A through 3C, the magnetic dots can have truncated cone shapes 32 and 34 or a truncated pyramid shape 36. The magnetic dots 30 may have a reversed (upside down) truncated pyramid shape.

The ratio of the dimension of a smaller surface to the dimension of a larger surface of the dots can be 0.9 or less, and preferably, in a range from 0.1 to 0.5.

The magnetic dots can be formed of at least one magnetic material selected from the group consisting of CoPt, CoPd, CoNi, CoTb, FePt, FePd, CoFeTb, CoFeGd, CoFeDy, CoFeHo, and CoFeNb having a magnetic anisotropic constant of 10⁵ J/m³ to 10⁷ J/m³. A low magnetic anisotropic constant of the magnetic dots 30 may cause switching instability.

The magnetic dots can also be formed as a laminate of a plurality of magnetic materials having different magnetic anisotropic constants as shown in FIG. 3D which depicts an exemplary embodiment of the magnetic dots in a recording layer of the magnetic recording medium of the present invention.

Referring to FIG. 3D, the magnetic dot 39 includes an upper layer 38 and a lower layer 37, and the upper layer 38 and the lower layer 37 have different magnetic anisotropic constants from each other. For example, the lower part 37 can be formed of a first magnetic material having a magnetic anisotropic constant of 10² J/m³ to 10³ J/m³, and the upper part 38 can be formed of a second magnetic material having a magnetic anisotropic constant of 10⁵ J/m³ to 10⁷ J/m³. Alternatively, the lower part 37 can be formed of the second magnetic material and the upper part 38 can be formed of the first magnetic material. FIG. 3D shows a magnetic dot of a laminate of two layers, but the present invention is not limited to the laminate of two layers. It also includes a magnetic dot of a plurality of layers in which the first magnetic material and the second magnetic material can be alternately stacked, or three or more different layers are stacked.

In one exemplary embodiment, the first magnetic material can be one selected from the group consisting of NiFe, CoFe, Ni, Fe, Co, and an alloy of these materials. Also, the second magnetic material can be one selected from the group consisting of CoPt, CoPd, CoNi, CoTb, FePt, FePd, CoFeTb, CoFeGd, CoFeDy, CoFeHo, and CoFeNb.

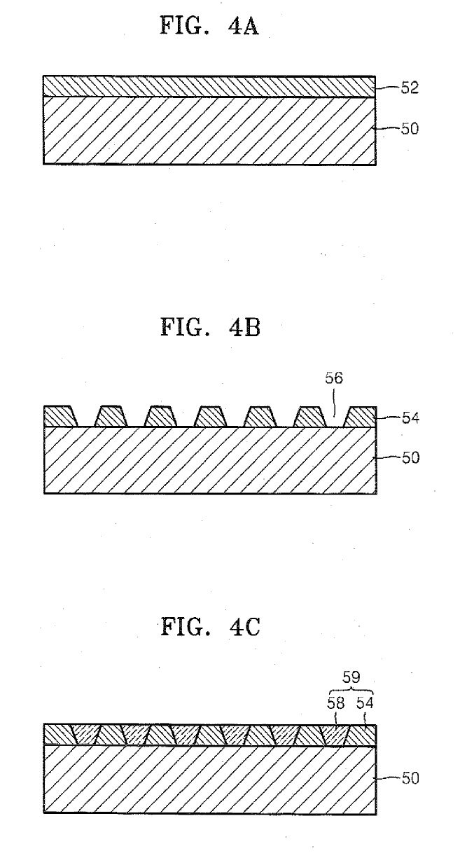

FIGS. 4A through 4C are cross-sectional views illustrating a method of fabricating a magnetic recording medium according to another embodiment of the present invention. In the present embodiment, magnetic dots are formed by coating a magnetic layer on a pattern after the pattern is formed using a nano imprint lithography method.

Referring to FIG. 4A, a mold layer 52 for forming a dot pattern is coated on the substrate 50, and the mold layer 52 is patterned. The mold layer 52 is coated to a thickness of a few tens of nanometers to a few tens of hundreds of nanometers using an imprint resin. The mold layer 52 is then hardened and becomes a non-magnetic region that separates magnetic dots.

Referring to FIG. 4B, the mold layer 52 is patterned to a pattern 54 having a pitch of a few nanometers to a few tens of nanometers using a nano imprint lithography method. The nano imprint lithography method can be a thermal imprint method in which imprinting is performed by applying heat or an UV imprint in which imprinting is performed by radiating ultraviolet rays. As depicted in FIG. 4B, the pattern 54 includes grooves 56, which each have a truncated cone shape.

Alternately, the mold layer 52 may be patterned using a photo lithography method, an E-beam lithography method, a holographic lithography method, or an X-ray lithography method.

Referring to FIG. 4C, a magnetic material is coated on the pattern 54 to fill the truncated cone shaped spaces 56, thereby forming magnetic dots 58. A recording layer 59 consists of the magnetic dots 58 and the pattern 54 which is a non-magnetic region.

The magnetic dots 58 can be formed of a magnetic material selected from the group consisting of CoPt, CoPd, CoNi, CoTb, FePt, FePd, CoFeTb, CoFeGd, CoFeDy, CoFeHo, and CoFeNb having a magnetic anisotropic constant of 10⁵ J/m³ to 10⁷ J/m³.

In FIG. 4C, it is depicted that the pattern 54 remains as a non-magnetic region that separates individual magnetic dots 58 from each other. However, after the magnetic material is filled in the truncated cone shaped grooves 56, it is possible to remove the pattern 54 and apply a non-magnetic material to regions between individual magnetic dots 58. The non-magnetic material can be a non-magnetic oxide or a non-magnetic nitride, for example, a non-magnetic material selected from the group consisting of SiO₂, TiO₂, ZrO₂, and SiN.

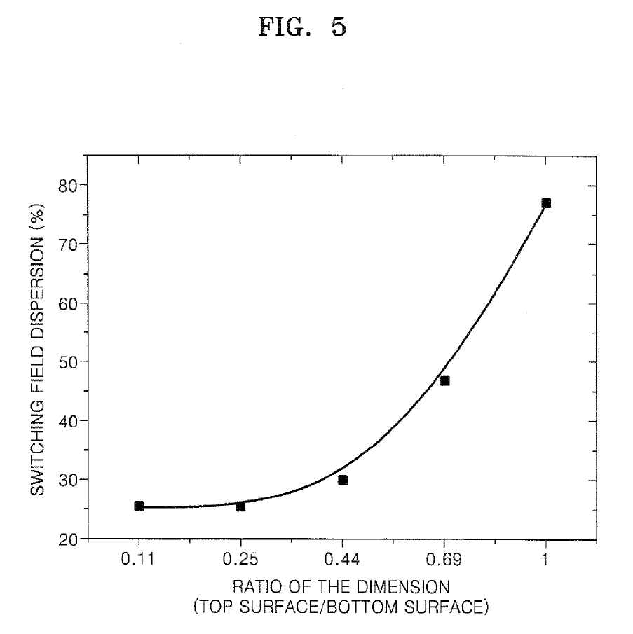

FIG. 5 is a graph showing a simulation result of a switching field dispersion characteristic according to a relative ratio of the dimension of one surface (here, the top surface) to the dimension of the opposite surface (here, the bottom surface) of a magnetic dot according to an embodiment of the present invention. In the present embodiment, the simulation of the switching field dispersion characteristic was performed using a magnetic recording medium having truncated cone shape dots, each having a top surface of which the dimension is smaller than that of a bottom surface area, and a relative ratio of the top surface dimension to the bottom surface dimension being from 0.1 to 1.

Referring to FIG. 5, as the relative ratio of the one surface dimension to the opposite surface dimension decreases, the switching field dispersion is reduced. When one surface dimension is not equal to the opposite surface dimension, compared to the case when the two opposite surfaces dimension are equal, the switching field dispersion is reduced. In particular, when the relative ratio of the one surface dimension to the opposite surface dimension is 0.1 to 0.5, the switching field dispersion is favorable.

As described above, a magnetic recording medium having a uniform and stable switching field characteristic can be realized by employing a plurality of magnetic dots in a recording layer, the magnetic dots each having a surface of which dimension which is not equal to the dimension of its opposite surface and the dots each forming an angle which is not equal to 90 degrees with respect to the substrate surface.

A method of fabricating a magnetic recording medium having magnetic dots according to the present invention can be used to fabricate a high density magnetic recording medium using a minute dot pattern of a few tens of nanometers.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetic recording medium comprising:
a substrate;
a recording layer formed on the substrate;
wherein the recording layer is formed of a plurality of discrete magnetic dots and a non-magnetic region, the non-magnetic region isolating each of the plurality of magnetic dots from each other;
wherein the magnetic dots each have a first surface and a second surface, the second surface being opposite to the first surface, in which the dimension of the first surface is not equal to the dimension of the second surface, and a sidewall of the respective magnetic dots form an angle which is not equal to 90 degrees with respect to the substrate surface.

2. The magnetic recording medium of claim 1, wherein a relative ratio of the dimension of the first surface to the dimension of the second surface is 0.9 or less.

3. The magnetic recording medium of claim 2, wherein a relative ratio of the dimension of the first surface to the dimension of the second surface is 0.1-0.5.

4. The magnetic recording medium of claim 1, wherein the magnetic dots have a truncated cone shape, truncated pyramid shape, a cone shape, reversed truncated cone shape, a reversed truncated pyramid shape.

5. The magnetic recording medium of claim 1, wherein the magnetic dots are formed of a material having a magnetic anisotropic constant of 10⁵ J/m³ to 10⁷ J/m³.

6. The magnetic recording medium of claim 5, wherein the magnetic is formed of at least one material selected from the group consisting of CoPt, CoPd, CoNi, CoTb, FePt, FePd, CoFeTb, CoFeGd, CoFeDy, CoFeHo, and CoFeNb.

7. The magnetic recording medium of claim 1, wherein the magnetic dots are arranged regularly.

8. The magnetic recording medium of claim 4, wherein the magnetic dots may have a combination of different shapes or a single shape.

9. The magnetic recording medium of claim 1, wherein the magnetic dots are a laminate of a plurality of layers, in which respective layer has a magnetic anisotropic constant different from the other layers.

10. The magnetic recording medium of claim 9, wherein the magnetic dots are formed of a first layer and a second layer, the first layer having a magnetic anisotropic constant of 10⁵ J/m³ to 10⁷ J/m³ and the second layer having a magnetic anisotropic constant of 10² J/m³ to 10³ J/m³.

11. The magnetic recording medium of claim 10, wherein the second layer is formed on the substrate and the first layer is formed on the second layer.

12. The magnetic recording medium of claim 10, wherein the first layer is formed on the substrate and the second layer is formed on the first layer.

13. The magnetic recording medium of claim 10, wherein the first layer is formed of a magnetic material selected from the group consisting of CoPt, CoPd, CoNi, CoTb, FePt, FePd, CoFeTb, CoFeGd, CoFeDy, CoFeHo, and CoFeNb.

14. The magnetic recording medium of claim 10, wherein the second layer is formed of a magnetic material selected from the group consisting of NiFe, CoFe, Ni, Fe, Co, and an alloy of these materials.

15. The magnetic recording medium of claim 1, further comprising a seed layer, a soft magnetic under layer, and an intermediate layer between the substrate and the recording layer.

16. The magnetic recording medium of claim 1, wherein the magnetic dots have perpendicular magnetic anisotropy.

17. A method of fabricating a magnetic recording medium, comprising:
forming a mold layer on a substrate, the mold layer being non-magnetic;
patterning the mold layer to form a pattern providing a plurality of grooves whose top area dimension is not equal to the dimension of a bottom area; and
filling a magnetic material in the grooves to form magnetic dots which each have the shape of the grooves.

18. The method of claim 17, wherein the pattern forms a non-magnetic region that isolates the magnetic dots from each other.

19. The method of claim 17, further comprising removing the pattern and applying a non-magnetic material to form a non-magnetic region that isolates the magnetic dots from each other.

20. The method of claim 17, wherein the pattern is formed using one method selected from the group consisting of a nano imprint lithography method, a photo lithography method, an E-beam lithography method, a holographic lithography method, and an X-ray lithography method

21. The method of claim 17, wherein a relative ratio of the dimension of one of the two surfaces to the dimension of the other surface is 0.9 or less.

22. The method of claim 21, wherein the relative ratio of the dimension of one of the two surfaces to the dimension of the other surface is 0.1-0.5.

23. The method of claim 17, wherein the magnetic dots have a truncated cone shape, truncated pyramid shape, cone shape, reversed truncated cone shape, or reversed truncated pyramid shape.

24. The method of claim 17, wherein the forming of the magnetic dots comprises applying sequentially a plurality of magnetic materials having different magnetic anisotropic constants to form magnetic dots which each are a laminate of plurality of layers.
